(19) United States
(12) Patent Application Publication
(10) Pub. No.: US 2002/0136748 A1
(43) Pub. Date: Sep. 26, 2002

(54) FORMULATIONS CONTAINING AN INSECTICIDE

(76) Inventors: MIKE-DIRK BUBLITZ, BURSCHEID (DE); RALF DUJARDIN, NOVI, MI (US); BURKHARD MIELKE, KURTEN (DE); DIETMAR KISTERS, KREFELD (DE)

Correspondence Address: NORRIS,MCLAUGHLIN & MARCUS,P.A., 220 EAST 42ND STREET, 30TH FLOOR, NEW YORK,, NY, 10017, US

(21) Appl. No.: 09/446,280

(22) PCT Filed: Jun. 17, 1998
(86) PCT No.: PCT/EP98/03652

(30) Foreign Application Priority Data
Jun. 30, 1997 (DE) 19727776.4
Apr. 16, 1998 (DE) 19816781.4

(51) Int. Cl. A01N 25/00

(52) U.S. Cl. 424/405

(57) ABSTRACT

The invention relates to insecticidal formulations based on polymers, to processes for their preparation and to their use for controlling insects encountered indoors. These novel formulations are characterized in that they contain at least one type of insecticide which is incorporated into an appropriate polymer. The formulations are capable of emitting the insecticide at a certain temperature in a controlled manner without changing their form and macroscopic appearance.

The invention relates to insecticide-containing formulations, to a process for producing these formulations and to their use for the control of insects.

Insect control systems based on heating devices are becoming more and more favoured. They are based on the principle that appropriate materials, such as cellulose or cotton card, asbestos or ceramic, are impregnated with an insecticidal active substance. These impregnated support materials can then be cut into shaped articles of whatever kind, preferably tablets (called “vaporizer tablets” below), which give off the active substance at elevated temperature. The insecticides are volatilized by the action of a heating device generating a temperature between 120 and 190° C. A similar principle forms the basis of the gel improviser, where the insecticide is incorporated into a gel formulation.

DE-A 196 05 581 discloses insecticidal compositions which are based on polymers and which give off the active substance at elevated temperature. Various pyrethroids are mentioned as possible active substances. Although these compositions meet many of the requirements of practice, there continues to be a need for improvements. In particular there is a desire for retarded exhaustion of the formulations, so that the user is required to change the shaped articles less often. For an extended life time of the compositions, the materials—active substance and polymer—must, however, also be able to withstand the associated temperature stresses; moreover, the polymers must be able to accommodate a relatively high proportion of active substance without the latter being undesirably exuded at room temperature. The object of the invention, therefore, was to provide insecticide-containing formulations having uniform active-substance release characteristics and a maximum duration of action.

It has surprisingly been found that formulations in which the insecticide is embedded in a polymer excellently fulfil this object if they contain an inorganic aggregate and/or if the polymer is poly-4-methylpentene.

The present invention therefore relates to formulations based on

A) at least one pyrethroid insecticide which is released at elevated temperatures and

B) at least one polymer having a softening point in the range between 100 and 300, preferably between 150 and 250, and most preferably between 150 and 200° C.,

characterized in that they contain an inorganic aggregate and/or in that the polymer is poly-4-methylpentene.

The softening range is the glass temperature in the case of amorphous thermoplastic polymers and the melting point in the case of semi-crystalline polymers. Additionally, further additives such as stabilizers, colorants or perfumes and customary organic or inorganic auxiliaries may be incorporated in the mixtures.

Preferred for use as pyrethroidal active compounds are:

1) 3-allyl-2-methyl-cyclopent-2-en-4-on-1-yl-d/l-cis/trans-chrysanthemate (allethrin/Pynamine®),

2) 3-allyl-2-methyl-cyclopent-2-en-4-on-1-yl-d-cis/trans-chrysanthemate (Pynamin forte®),

3) 3-allyl-2-methyl-cyclopent-2-en-4-on-1-yl-d-trans-chrysanthemate (Bioallethrin®),

4) 2,3,5,6-tetrafluorobenzyl (+)-1R-trans-2,2-dimethyl-3-(2,2-dichlorovinyl)-cyclopropanecarboxylate (transfluth rin, Bayothrin®)

5) (S)-3-propargyl-2-methyl-cyclopent-2-en4-on-1-yl-(1 R)-cis/trans-chrysanthemate (prallethrin/Etoc®), or mixtures of these active compounds.

Particular preference is given to the active compounds 3-allyl-2-methyl-cyclopent-2-en-4-on-1-yl-d-cis/trans-chrysanthemate (Pynamin forte®) and 2,3,5,6-tetrafluorobenzyl (+)-1R-trans-2,2-dimethyl-3-(2,2-dichlorovinyl)-cyclopropanecarboxylate (transfluth rin).

Preferred polymeric materials are amorphous and semi-crystalline polymers and mixtures of these two which can be processed thermoplastically, i.e. as a viscous melt, and whose softening range is below the boiling point at atmospheric pressure of the active compounds to be incorporated. The polymers for the active compound in question are selected so that the active compound is at least partly miscible with the polymer.

Preferred Appropriate Polymers are:

PVC (SOFT), polystyrene, styrene/butadiene, styrene/acrylonitrile, acrylonitrile/butadiene/styrene, polymethylacrylate, amorphous polycycloolefins, cellulose esters, aromatic polycarbonates, amorphous aromatic polyamides, polyphenylene ethers, poly (ether) sulphones, polyimides, polyethylene, polypropylene, polybutylene, polymethylpentene, PVC (HARD), polyamide, polyetheramides, polyesteramides, polyoxymethylene, polyethylene terephthalate, polybutylene terephthalate, polyimide, polyether (ether) ketone and polyurethanes. Preferred mixtures are, for example: blends of polycarbonates with polybutylene terephthalate, blends of polyamide-6 and styrene/acrylonitrile, blends of polypropylene and polymethylpentene.

Particular preference is given to polypropylene, poly-4-methyl-1-pentene and mixtures thereof.

The invention preferably relates to formulations of mixtures comprising

A.from 0.1 to 80, preferably from 0.2 to 40, in particular from 0.5 to 20 and, especially, from 1 to 10% by weight of transfluthrin

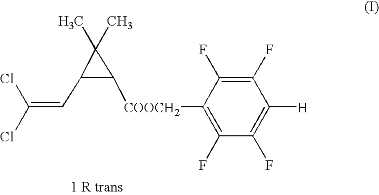

and

B.from 99.9 to 20, preferably from 99.8 to 60, in particular from 99.5 to 80 and, especially, from 99 to 90% by weight of poly-4-methyl-1-pentene, which in turn may be replaced up to half, preferably up to a third and, in particular, up to a quarter of its weight by another poly-α-olefin,

the percentages being based in each case on the sum of the components A+B.

Transfluthrin and a process for its preparation are known from DE-A 37 05 224 (=EP-B 279 325).

Poly-4-methyl-1-pentene B is a polymer, preferably having a glass transition temperature of from 50 to 60° C., a softening temperature measured in accordance with Vicat (ASTM D 1525) of from 140 to 180, preferably from 170 to 175° C. and a melt index (260° C./5 kg), measured in accordance with ASTM D 1238, of from 20 to 200, preferably from 22 to 35 [g/l 0 min], which it is known can be prepared by polymerizing 4-methyl-1-pentene.

Suitable poly-α-olefins which may partly replace the poly-4-methyl-1-pentene are primarily polyethylenes, polypropylenes, polybutenes and polyisobutenes, and also copolymers of the α-olefins on which the said polymers are based, such as, for example, ethylene-propylene copolymers. Preferred polypropylenes comprise iso- and/or syndiotactic polypropylenes, preferably having a softening-temperature measured in accordance with Vicat (ISO 306) of from 130 to 170, preferably from 140 to 160° C. and a melt index (230° C./2 kg), measured in accordance with ISO 1133, of from 20 to 40, preferably from 25 to 35 [g/l 0 min]. Insofar as “other” poly-α-olefins are also used, the weight ratio of poly-4-methyl-1 -pentene/poly-α-olefins can be from 70:30 to 99:1, preferably from 80:20 to 95:5.

In addition to the components A and B, the formulations according to the invention can include further organic and/or inorganic additives, such as, for example, fillers, colorants, stabilizers, fragrances.

The insecticidal compositions according to the invention can be stabilized with the aid of antioxidants by admixing a UV absorber as additive to the formulation. Suitable UV absorbers are all known UV absorbers.

Preference is given to using phenol derivatives, such as, for example, butylhydroxytoluene (BHT), butylhydroxyanisole (BHA), bisphenol derivatives, arylamines, such, as, for example, phenyl-α-naphthylamine, phenyl-β-naphthylamine, a condensate of phenetidine and acetone or the like or benzophenones.

It is possible to use colorants, such as inorganic pigments, for example iron oxide, titanium oxide, Prussian blue, and dyestuffs, such as, for example, alizarin, azo dyestuffs and metal phthalocyanine dyestuffs.

Examples of synthetic perfumes which can be added to the gel formulations according to the invention are:

pinene, limonene and similar hydrocarbons; 3,3,5-trimethylcyclohexanol, linalool, geraniol, nerol, citronellol, menthol, borneol, borneylmethoxycyclohexanol, benzyl alcohol, anisyl alcohol, cinnamyl alcohol, R-phenylethyl alcohol, cis-3-hexanof, terpineol and similar alcohols; anetholes, musk xylene, isoeugenol, methyleugenol and similar phenols: α-amylcinnamaldehyde, anisaldehyde, n-butyraldehyde, cuminaldehyde, cydlamenaldehyde, decyl aldehyde, isobutyraldehyde, hexaldehyde, heptaldehyde, n-nonyl aldehyde nonadienol, citral, citronellal, hydroxycitronellal, benzaldehyde, methylnonyl acetaldehyde, cinnamaldehyde, dodecanol, α-hexylcinnamaldehyde, undecanal, heliotropin, vanillin, ethylvanillin, and similar aldehydes, methyl amyl ketone, methyl β-naphthyl ketone, methyl nonyl ketone, musk ketone, deacetyl, acetylpropionyl, acetylbutyryl, carvone, methone, camphor, acetophenone, p-methylacetophenone, ionone, methylionone and similar ketones; amyl-butyrolactone, diphenyl oxide, methylphenyl glycidate, nonylacetone, coumarin, cineol, ethylmethylphenyl glycidate and similar lactones or oxides, methyl formate, isopropyl formate, linalyl formate, ethyl acetate, octyl acetate, methyl acetate, benzyl acetate, cinnamyl acetate, butyl propiant, isoamyl acetate, isopropyl isobutyrate, geranyl isovalerate, allyl capronate, butyl heptylate, octyl caprylate, methyl heptinecarboxylate, methyl octinecarboxylate, isoamyl caprylate, methyl laurate, ethyl myristate, methyl myristate, ethyl benzoate, benzyl benzoate, methylcarbinylphenyl acetate, isobutylphenyl acetate, methyl cinnamate, styracin, methyl salicylate, ethyl anisate, methyl anthranilate, ethyl pyruvate, ethyl α-butylbutyrate, benzyl propionate, butyl acetate, butyl butyrate, p-tert-butylcyclohexyl acetate, deryl acetate, citronellyl acetate, citronellyl formate, p-cresyl acetate, ethyl butyrate, ethyl caproate, ethyl cinnamate, ethylphenyl acetate, ethylene brassylate, geranyl acetate, geranyl formate, isoamyl salicylate, isoamyl valerate, isobornyl acetate, linalyl acetate, methyl anthranilate, methyl dihydrojasmonate, nonyl acetate, β-phenylethyl acetate, trichloromethylenephenylcarbinyl acetate, terpinyl acetate, vetiveryl acetate and similar esters.

The formulations generally comprise between 0.1 and 80%, preferably between 0.2 and 40%, particularly preferably between 1.0 and 20%, of active compound.

Aggregates which may be used include modifiers and/or fillers and reinforcement materials and/or processing auxiliaries such as, for example, nucleating agents, plasticizers, release agents, flameproofing agents, impact resistance modifiers, stabilizers or other additives which are customarily used for thermoplastics. Preference is given to using fillers as described in Encyclopaedia of Polymer Science and Engineering, Vol. 7, pp. 53-73 (1985).

Fillers and reinforcement materials which may be used are minerals such as, for example, gypsum, lime, glass fibres or sand, preferably glass fibres.

The formulations according to the invention can be prepared by introducing the polymer B, as granules or powder, into an appropriate kneader or extruder and plastifying it. Under the plastification conditions and temperatures typical for the polymer, the active substance A can be introduced directly into the polymer melt, by way of an appropriate metering device, and distributed uniformly.

The plastification of the polymers can take place in kneaders (Banbury, Werner & Pfleiderer), including special kneaders, and also in variable shearing-roll extruders and in single- and twin-screw extruders.

Shearing-roll extruders are used primarily for batch productions, while with single- and/or twin-screw extruders or Buss KO-kneaders it is possible to incorporate the active substance continuously. Suitable extruders or kneaders for the incorporation of the active substance are based on the principle of friction; the frictional heat comes about in the course of the horizontal forwards and backwards movement of the screws. The screws may differ in flight depths, channel widths, helix angles in the direction of rotation, depending on the polymer/active substance mixture. The quality of the homogenization can be adjusted by way of the kneading time and the length/diameter ratio of the extruder screws.

In order to obtain homogeneous products for thermoplastic processing to moulding compounds, metering in the following form is advisable: the addition of the polymer takes place preferably in granule or powder form.

The active substance can be added in solid or liquid form (as melt or solution) depending on the required accuracy, with the aid of volumetric or gravimetric metering devices. Volumetric metering devices include screw, star, carousel and vibrating-chute feeders. Gravimetric metering devices are, for example, proportioning belt weighers or differential weigh feeders. For free-flowing polymer granules (particle size>50 μm) it is favourable to employ, as metering devices, vibrating chutes, spiral screws or bladed screws, and belts. Active substance with powder sizes between 10 and 50 μm can be treated like a liquid and can be metered in preferably using “chamber systems”, such as cellular-wheel sluices or double-lead screws. The active substance can be added to the filling zone of the extruder or further downstream in one or more stages. Metering takes place preferably into the polymer melt in order to avoid the formation of secondary agglomerates.

Liquid active substance can be added, for example, to the premixer (heating/cooling mixer). Waxlike active substance can first be melted at from 60 to 80° C. and stored in a thermostated reservoir vessel before being supplied to the extruder. Liquid active substance can be metered in with gear pumps, small screw pumps or single or multiple piston pumps. It is supplied to the extruder preferably at a point where the melt is under pressure. The melt pressure should be above the vapour pressure of the active substance at the respective melt temperature, since otherwise vapour and foam are formed. At the injection site, the pressure should fall in the direction of the screw tip - in other words, the pressure gradient should be negative - so that the active substance fed in is not “pressed off” upstream. With relatively large amounts of active substance and large differences in viscosity between polymer and liquid active substance, it is advantageous to inject the liquid simultaneously at two or more sites. In the case of thermally sensitive active substances it is possible by this means to distribute the active substance more rapidly in the melt. The important factor is that liquid active substance is embedded as directly as possible into the melt and not injected only at the edge of the internal barrel wall. Film formation by low-viscosity liquids on the barrel wall can be avoided by reducing the rate of addition; otherwise, conveying may be impaired or, in the case of single-screw extruders, may even collapse. In this case it is possible to use injection valves which project into the screw channel. The screw flight is then interrupted at the injection site. A situation to be avoided at all costs is that where, when the metering pump is switched off, polymer melt penetrates into the injection valve and into the feed line, where it solidifies and blocks the liquid feed when the metering pump is switched on again. In order to avoid this effect it is possible to use special spring-loaded non-return valves in which the non-return valve lies directly on the outlet aperture.

In terms of incorporation by mixing, the process for liquid active substance is in principle the same as for solid active substance. Since, however, the metered liquids are in the majority of cases of much lower viscosity than the polymer melt, the problem of their division in the course of homogenization does not arise. They need essentially only be distributed. Annular mixing elements are suitable for this purpose, since they bring about a multiply alternating division and spreading of the individual layers. Constant mixing quality can also be achieved by means of static mixing elements installed between conveying screw and die.

The metering of liquid or solid active substance can also take place in the form of active-substance concentrates. The concentrates are intermediates which comprise the active substance embedded in a high concentration in carrier substances. The carrier substance in this instance can be the polymer B or a material (polymer, filler) which is immiscible with the polymer B. For the end use, the product is diluted back to the desired, low concentration by admixing further polymer granules. The highly concentrated active substance in this form has the function of being a readily meterable active-substance concentrate for different concentrations that are to be established. Usually, these “masterbatches” are in granule form.

The polymers containing active substance can be granulated by various means. For example, either extruded and fully or partly cooled strands are cut (strand pelletization), or else the hot melt is cut directly as it emerges from the die prior to the head (e.g. water-cooled die face pelletization).

The granules containing active substance that are prepared can be processed further as thermoplastics, to give mouldings, or can be processed with further polymer to form mixtures (masterbatch).

Shaping can be carried out using the customary techniques to be employed for plastics, such as, for example, processing by injection moulding, extrusion blow moulding, film extrusion or thermoforming.

The invention therefore additionally provides a process for producing the formulations according to the invention by mixing the components and shaping the resultant mixture.

The formulations according to the invention can be employed in the form of vaporizer tablets in conventional vaporizers as are used, for example, for cellulose vaporizer tablets. Operating temperatures of from 60 to 180, preferably from 130 to 170° C. ensure a long-lasting, relatively uniform release of active substance to the surroundings.

The invention additionally provides for the use of the formulations according to the invention for the control of insects such as, for example, flies and mosquitos.

The percentages in the examples which follow relate in each case to the weight.

### EXAMPLES

Starting Materials Used:

1. Poly-4-methyl-1-pentene from Mitsui (polymethylpentene TPX RT 18)

2. Polypropylene (Hostalen PPV 2080, PPV 2700 L, PPV 2780 L from Hoechst AG)

3. Titanium dioxide (Bayer Titan RFK-2 from Bayer AG)

### Example 1

Compounding of Active Compounds into Various Polymers

Compounding was carried out using a two-shaft measuring extruder (extruder type: 35/17 D, extruder cooling: air, inlet cooling: water, 3 mm round extruder die, four electrically heated heating zones).

The polymer granules are metered into the extruder at the respective temperature using a balance. The active compound is heated in a storage container heated with water-vapour and added using a gear-type metering pump. The throughput is adjusted to a total of 6 kg/h.

The discharged polymer extrudate is cooled in a water-bath and then comminuted in the granulator. The granules are dried at about 50° C. under water-pump vacuum.

| | | Active | | | | | | | | |
|---|---|---|---|---|---|---|---|---|---|---|
| | | com- | Heating zone temperature | | | | | | Pres- | Number of |
| Ex- | | pound | [° C.] | | | | Die | Torque | sure | revolutions |
| ample | Polymer | % | 1 | 2 | 3 | 4 | [mn] | [Nm] | [bar] | [1/min] |
| 1.1 | TPX RT 18 | 3.4 | 270 | 280 | 280 | 280 | 3.0 | 16 | 12 | 60 |
| 1.2 | TPX RT 18 | 2.0 | 270 | 280 | 280 | 280 | 3.0 | 18 | 16 | 60 |
| 1.3 | TPX RT 18 | 1.0 | 270 | 280 | 280 | 280 | 3.0 | 19 | 15 | 60 |
| 1.4 | TPX RT 18 | 1.5 | 270 | 280 | 280 | 280 | 3.0 | 19 | 16 | 60 |
| 1.5 | TPX RT 18/ | 0.95 | 270 | 270 | 270 | 270 | 3.0 | 27 | 23 | 40 |
| | glass fibre | | | | | | | | | |
| 1.6 | TPX RT 18/ | 1.35 | 270 | 270 | 270 | 270 | 3.0 | 27 | 23 | 40 |
| | glass fibre | | | | | | | | | |
| 1.7 | PP/ | 4.0 | 240 | 250 | 250 | 250 | 3.0 | 26 | 21 | 60 |
| | glass fibre | | | | | | | | | |
| 1.8 | PP/ | 4.0 | 240 | 250 | 250 | 250 | 3.0 | 23-24 | 17 | 60 |
| | mineral | | | | | | | | | |
| 1.9 | PP/ | 4.0 | 180 | 190 | 190 | 190 | 3.0 | 18 | 19 | 60 |
| | mineral | | | | | | | | | |

* TPX RT 18 polymethylpentene
** PP Hostalen PPV 2080
No. 1.9. Hostalen PPV 2780 L

### Example 2

Comparison with and without Aggregates

The weight samples are placed in the middle of the heater and are weighed accurately every 2 h once the heating device has been switched on. The tests are carried out until the calculated time of use of 10 h has been reached.

Heating device: Baygon Mückenfrei Heizgerät, Standard Germany, having a fixed resistor, 155° C.

Sample: 34×22×2.5 mm

Cycle: 2-10 h

| | | Dimen- | | | | | | |
|---|---|---|---|---|---|---|---|---|
| Example | | sions | Preparation | Loss of weight in mg | | | | |
| No. | Material | mm | Example | 2 h | 4 h | 6 h | 8 h | 10 h |
| 2.1 | Polymethylpentene | 34 × 22 × 2.5 | | 33.5 | 47.5 | 52.0 | 59.0 | 63.0 |
| | (TRX RT 18) | | | | | | | |
| 2.2 | Polymethylpentene/ | 34 × 22 × 2.5 | | 23.9 | 45.7 | 56.6 | 63.9 | 70.4 |
| | 20% glass fibre | | | | | | | |

The comparison of polymethylpentene with and without the addition of 20% of glass fibre shows the considerable increase of the amount that has been evaporated.

### Example 3

Comparison of Different Sizes

The weight samples are placed in the middle of the heater and are weighed accurately every 2 h once the heating device has been switched on. The tests are carried out until the calculated time of use of the sample of 10 h has been reached.

Heating Devices:

Baygon Mückenfrei Heizgerät, Standard Germany, having a fixed resistor, 155° C. (Examples 3.1 and 3.2).

Baygon Electrico Heater Brazil having a PTC resistor, 155° C. (Examples 3.3 and 3.4).

Active compound: transfluthrin (1.3%)

Cycle: 2-10 h

| | | Dimen- | | | | | | |
|---|---|---|---|---|---|---|---|---|
| Example | | sions | Preparation | Loss of weight in mg | | | | |
| No. | Material | mm | Example | 2 h | 4 h | 6 h | 8 h | 10 h |
| 3.1 | Polymethylpentene | 34 × 22 × 2.5 | | 33.5 | 47.5 | 52.0 | 59.0 | 63.0 |
| 3.2 | Polymethylpentene/ | 34 × 22 × 2.5 | | 23.9 | 45.7 | 56.6 | 63.9 | 70.4 |
| | 20% glass fibre | | | | | | | |
| 3.3 | Polymethylpentene | 40 × 18 × 2.5 | | 23.5 | 30 | 34 | 38 | 43 |
| 3.4 | Polymethylpentene/ | 40 × 18 × 2.5 | 20.0 | 36.1 | 42.0 | 45.2 | 46.1 | |
| | 20% glass fibre | | | | | | | |

In this example, the addition of 20% of glass fibre also led to improved evaporation properties. This effect is more pronounced in the Brazil format 40 mm×18 mm×2.5 mm than in the format 34 mm×22 mm×2.5 mm.

### Example 4

Comparison of Different Active Compound Contents

The weight samples are placed in the middle of the heater and are weighed accurately every 2 h once the heating device has been switched on. The tests are carried out until the calculated time of use of the sample of 10 h has been reached.

Heating device: Baygon Mückenfrei Heizgerät, Standard Germany having a fixed resistor, 155° C.

Sample: 34×22×2.5 mm

Cycle:2-10h

| | | | | Relative loss of weight in %, | | | | |
|---|---|---|---|---|---|---|---|---|
| Example | | Active | Preparation | (total content = 100%) | | | | |
| No. | Material | compound | Example | 2 h | 4 h | 6 h | 8 h | 10 h |
| 4.1 | Polymethylpentene/ | 0.95% | | 28.4 | 37.5 | 47.5 | 50.6 | 55.0 |
| | 20% glass fibre | transfluthrin | | | | | | |
| 4.2 | Polymethylpentene/ | 1.3% | | 23.9 | 45.7 | 56.6 | 63.9 | 70.4 |
| | 20% glass fibre | transfluthrin | | | | | | |

### Example 5

Aggregates in Polypropylene (100° C. Version)

The weight samples are placed in the middle of the heater and are weighed accurately every 10 h once the heating device has been switched on. The tests are carried out until the calculated time of use of the sample of 70-80 h has been reached.

Temperature: 115° C.

DBK heating device GD type having PTC.

Sample: 6.25 cm

Cycle: 1×10 h/day

Duration: 7 days

| | Amount of | | | | | | | | |
|---|---|---|---|---|---|---|---|---|---|
| | active | | | | | | | | Total |
| Example | compound | | Thickness | 10 h | 20 h | 40 h | 60 h | 70 h | release |
| No. | (mg) | Polymer | mm | mg/h | mg/h | mg/h | mg/h | mg/h | (%) |
| 5.1 | 47 | PP without | 2 | 1.26 | 0.61 | 0.34 | 0.26 | 0.26 | 80 |
| | | additives | | | | | | | |
| 5.2 | 50 | PP + | 2 | 1.72 | 0.73 | 0.37 | 0.26 | 0.26 | 90 |
| | | glass fibre | | | | | | | |

### Example 6

Preparing the Vaporizer Tablets

Shaping takes place by injection moulding on an Arburg 320-210-850 machine, single screw with a diameter of 35 mm, screw charge about 125 g (corresponds to five shots) with an inverse temperature profile of 250° C. (die) 265° C./270° C./280° C. and a cycle time of 15 seconds. The mould temperature is 30° C.; a cold runner mould, 12-fold, with tunnel gating is used. As the initial run, ten shots each of 25 g are taken. The product is dried at 50° C. for 15 h.

| | | |
|---|---|---|
| Example | Constituents | Content [%] |

Vaporizer tablets for use over several days

| | | |
|---|---|---|
| 6.1. | Polymethylpentene | 92.9 |
| | Transfluthrin | 6.6 |
| | Butylated hydroxytoluene | 0.5 |
| 6.2. | Polymethylpentene | 91.2 |
| | Transfluthrin | 8.3 |
| | Butylated hydroxytoluene | 0.5 |

Vaporizer tablets for use over one night

| | | |
|---|---|---|
| 6.3. | Polymethylpentene | 83.0 |
| | Polypropylene | 14.6 |
| | Transfluthrin | 1.32 |
| | Titanium dioxide | 1.0 |
| | Butylated hydroxytoluene | 0.06 |
| | Colorant Sudan Blue 670 | 0.01 |
| 6.4. | Polymethylpentene | 97.9 |
| | Transfluthrin | 2.0 |
| | Butylated hydroxytoluene | 0.1 |

### Example 7

Release of Active Substance by the Formulations According to the Invention

The release of active substance is determined gravimetrically. The weighed test specimens are placed centrally on the cold heating devices (customary commercial FALP standard heating devices for Baygon vaporizer tablets) and weighed precisely after the respective cycles. The tests are conducted until the test specimens show no further loss in weight.

Dimensions of the test specimens: 34 mm×23 mm×2.5 mm.

Duration of cycles: 8 h/day.

### Example 7.1

Release rates of the formulation from Example 6.1. over 7 cycles:

| Duration | | Release |
|---|---|---|
| [h] | Cycle | [mg/h] |
| 8 | 1 | 5.6875 |
| 16 | 2 | 2.2125 |
| 24 | 3 | 1.4125 |
| 32 | 4 | 1.0625 |
| 40 | 5 | 0.8 |
| 48 | 6 | 0.7 |
| 56 | 7 | 0.4375 |

### Example 7.2

Release rates of the formulation from Example 6.2. over 7 cycles:

| Duration | | Release |
|---|---|---|
| [h] | Cycle | [mg/h] |
| 8 | 1 | 7.2 |
| 16 | 2 | 2.9375 |
| 24 | 3 | 2.0375 |
| 32 | 4 | 1.3125 |
| 40 | 5 | 1.1125 |
| 48 | 6 | 0.9125 |
| 56 | 7 | 0.5875 |

### Example 7.3

Cumulative release rates of the formulation from Example 6.3. over one cycle of 10 h:

| | Test a | Test b | Average |
|---|---|---|---|
| Duration [h] | (Release in mg) | (Release in mg) | (Release in mg) |
| 2 | 3.54 | 3.06 | 3.3 |
| 4 | 6.03 | 5.18 | 5.605 |
| 6 | 7.45 | 7 | 7.225 |
| 8 | 8.9 | 8.12 | 8.51 |
| 10 | 9.69 | 9.8 | 9.745 |

### Example 7.4

Cumulative release rates of the formulation from Example 6.4. over one cycle of 10 h:

| | Test a | Test b | Average |
|---|---|---|---|
| Duration [h] | (Release in mg) | (Release in mg) | (Release in mg) |
| 2 | 5.2 | 5.4 | 5.3 |
| 4 | 7.5 | 7.1 | 7.3 |
| 6 | 9.6 | 8.5 | 9.1 |
| 8 | 10.8 | 8.7 | 9.8 |
| 10 | 10.7 | 10.1 | 10.4 |

### Example 8

Testing of vaporizer tablets and long-term vaporizers for insecticidal action against flying insects in 34 m³ rooms

Materials and Method

The tests are carried out in rooms having the following dimensions:

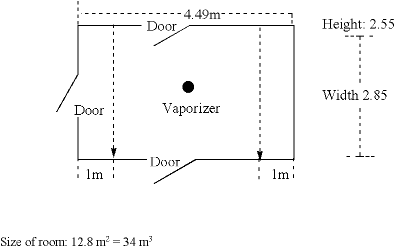

The respective system is placed on the floor in the centre in the empty rooms. In the case of plug versions, the systems are fixed on a stand at a height of 30 cm. At a distance of one meter from the narrow sides, at a height of 2 m, cords are stretched on which wire baskets with test animals are hung. The doors are closed. The temperature is regulated by radiators.

In the morning, operation of the respective vaporizer system is begun and at the same time 2 wire baskets each containing 20 test animals (3-4 days old) are hung in the room. At hourly intervals up to 8 hours, further animals are hung in the room and evaluated for knock-down effect every 15 minutes. The 50% and 100% knock-down effect, and mortality after 24 hours, are determined. The system is heated for up to 8 hours and then switched off. In the case of long-term vaporizers, the system is operated further for 8 hours a day, regulated by way of a time switch.

Test Animals:

Mosquitos:Aëdes aegypti mf, sensitive

Culex quinquefasciatus mf, DDT-resistant

| | | | | | | Room temperature: | | | |
|---|---|---|---|---|---|---|---|---|---|
| | | | | | | 21-27° C. Relative | | | |
| | | | | | | atmosphere humidity: 26-38% | | | |
| | | Heater: Falp | | | | Heater: Falp | | | |
| | | standard 158° C. | | | | standard 158° C. | | | |
| | | Tablets from Example 1.1. | | | | Tablets from Example 1.2. | | | |
| Test | | 6.6% transfluthrin = | | | | 8.3% transfluthrin = | | | |
| after | Insects | 108 mg of active substance | | | | 136 mg of active substance % | | | |
| days | exposed | kd effect in | | kd | Mort. | kd effect in | | kd | Mort. |
| Time | after | h and min | | after | after | h and min | | after | after |
| (hours) | hours | 50% | 100% | 9 h* | 24 h* | 50% | 100% | 9 h* | 24 h* |
| 1st day | 0 | 14′ | 18′ | 100 | 100 | 15′ | 19′ | 100 | 100 |
| | 1 | 2′ | 3′ | 100 | 100 | 2′ | 3′ | 100 | 100 |
| | 2 | 2′ | 3′ | 100 | 100 | 2′ | 3′ | 100 | 100 |
| | 3 | 2′ | 3′ | 100 | 100 | 2′ | 3′ | 100 | 100 |
| | 4 | 2′ | 3′ | 100 | 100 | 2′ | 3′ | 100 | 100 |
| | 5 | 2′ | 3′ | 100 | 100 | 2′ | 3′ | 100 | 100 |
| | 6 | 2′ | 3′ | 100 | 100 | 2′ | 3′ | 100 | 100 |
| | 7 | 2′ | 3′ | 100 | 100 | 2′ | 3′ | 100 | 100 |
| 8 h | 8 | 2′ | 3′ | 100 | 100 | 2′ | 3′ | 100 | 100 |
| 2nd day | 0 | 22′ | 36′ | 100 | | 23′ | 33′ | 100 | |
| | 1 | 2′ | 3′ | 100 | | 2′ | 3′ | 100 | |
| | 2 | 2′ | 3′ | 100 | | 2′ | 3′ | 100 | |
| | 3 | 2′ | 3′ | 100 | | 2′ | 3′ | 100 | |
| | 4 | 2′ | 3′ | 100 | | 2′ | 3′ | 100 | |
| | 5 | 2′ | 3′ | 100 | | 2′ | 3′ | 100 | |
| | 6 | 2′ | 4′ | 100 | | 2′ | 3′ | 100 | |
| | 7 | 2′ | 3′ | 100 | | 2′ | 3′ | 100 | |
| 16 h | 8 | 2′ | 3′ | 100 | | 2′ | 3′ | 100 | |
| 5th day | 0 | 45′ | 1 h 10′ | 100 | 100 | 41′ | 56′ | 100 | 100 |
| | 1 | 5′ | 16′ | 100 | 100 | 6′ | 18′ | 100 | 100 |
| | 2 | 28′ | 1 h 05′ | 100 | 100 | 33′ | 1 h 16′ | 100 | 100 |
| | 3 | 35′ | 1 h 09′ | 100 | 100 | 32′ | 1 h 11′ | 100 | 100 |
| | 4 | 7′ | 20′ | 100 | 100 | 7′ | 32′ | 100 | 100 |
| | 5 | 5′ | 16′ | 100 | 100 | 5′ | 18′ | 100 | 100 |
| | 6 | 5′ | 12′ | 100 | 100 | 4′ | 9′ | 100 | 100 |
| | 7 | 5′ | 9′ | 100 | 100 | 5′ | 7′ | 100 | 100 |
| 40 h | 8 | 6′ | 14′ | 100 | 100 | 7′ | 19′ | 100 | 100 |
| 6th day | 0 | 1 h 30′ | 2 h 13′ | 100 | 100 | 1 h 14′ | 1 h 44′ | 100 | 100 |
| | 1 | 26′ | 1 h 14′ | 100 | 100 | 23′ | 1 h 13′ | 100 | 100 |
| | 2 | 59′ | 1 h 24′ | 100 | 100 | 11′ | 27′ | 100 | 100 |
| | 3 | 14′ | 1 h 20′ | 100 | 100 | 15′ | 24′ | 100 | 100 |
| | 4 | 35′ | 1 h 15′ | 100 | 100 | 26′ | 42′ | 100 | 100 |
| | 5 | 27′ | 1 h 07′ | 100 | 100 | 10′ | 41′ | 100 | 100 |
| | 6 | 42′ | 1 h 14′ | 100 | 100 | 11′ | 21′ | 100 | 100 |
| | 7 | 46′ | >2 h | 90 | 100 | 14′ | 33′ | 100 | 100 |
| 48 h | 8 | 40′ | >1 h | 63 | 100 | 8′ | >1 h | 98 | 100 |

*kd/mortality following commencement of operation of the heating devices

| | | | | | | Room temperature | | | |
|---|---|---|---|---|---|---|---|---|---|
| | | | | | | 21-27° C. Relative | | | |
| | | | | | | atmospheric humidity: 26-38% | | | |
| | | Heater: Falp | | | | Heater: Falp | | | |
| | | standard 158° C. | | | | standard 158° C. | | | |
| | | Tablets from Example 1.1. | | | | Tablets from Example 1.2. | | | |
| Test | | 6.6% transfluthrin = | | | | 8.3% transfluthrin = | | | |
| after | Insects | 108 mg of active substance | | | | 136 mg of active substance % | | | |
| days | exposed | kd effect in | | kd | Mort. | kd effect in | | kd | Mort. |
| Time | after | h and min | | after | after | h and min | | after | after |
| (hours) | hours | 50% | 100% | 9 h* | 24 h* | 50% | 100% | 9 h* | 24 h* |
| 1st day | 0 | 32′ | 43′ | 100 | 100 | 34′ | 53′ | 100 | 100 |
| | 1 | 36′ | 50′ | 100 | 100 | 30′ | 1 h 03′ | 100 | 100 |
| | 2 | 25′ | 44′ | 100 | 100 | 29′ | 53′ | 100 | 100 |
| | 3 | 27′ | 45′ | 100 | 100 | 33′ | 1 h 10′ | 100 | 100 |
| | 4 | 29′ | 59′ | 100 | 100 | 31′ | 1 h 03′ | 100 | 100 |
| | 5 | 23′ | 45′ | 100 | 100 | 33′ | 53′ | 100 | 100 |
| | 6 | 39′ | 1 h 08′ | 100 | 100 | 30′ | 53′ | 100 | 100 |
| | 7 | 25′ | 1 h 00′ | 100 | 100 | 14′ | 42′ | 100 | 100 |
| 8 h | 8 | 24′ | >1 h | 80 | 100 | 22′ | >1 h | 90 | 100 |
| 2nd day | 0 | 1 h 29′ | 2 h 00′ | 100 | | 1 h 22′ | 1 h 42′ | 100 | |
| | 1 | 2 h 25′ | 3 h 00′ | 100 | | 1 h 38′ | 2 h 18′ | 100 | |
| | 2 | 1 h 28′ | 1 h 50′ | 100 | | 1 h 35′ | 2 h 34′ | 100 | |
| | 3 | 1 h 17′ | 2 h 28′ | 100 | | 1 h 03′ | 1 h 48′ | 100 | |
| | 4 | 1 h 25′ | 2 h 23′ | 100 | | 1 h 05′ | 1 h 57′ | 100 | |
| | 5 | 57′ | 1 h 48′ | 100 | | 48′ | 1 h 38′ | 100 | |
| | 6 | 1 h 30′ | >3 h | 95 | | 1 h 12′ | 2 h 05′ | 100 | |
| | 7 | 1 h 13′ | >2 h | 80 | | 1 h 18′ | >2 h | 75 | |
| 16 h | 8 | >l h | >1 h | 23 | | >1 h | >1 h | 30 | |
| 5th day | 0 | 6 h 25′ | >9 h | 93 | 100 | 5 h 38′ | 7 h 13′ | 100 | 100 |
| | 1 | 5 h 20′ | >8 h | 93 | 100 | 5 h 28′ | 6 h 43′ | 100 | 100 |
| | 2 | >7 h | >7 h | 38 | 90 | 4 h 15′ | >7 h | 98 | 100 |
| | 3 | >6 h | >6 h | 0 | 70 | 5 h 08′ | >6 h | 70 | 95 |
| | 4 | >5 h | >5 h | 0 | 70 | >5 h | >5 h | 10 | 85 |
| | 5 | >4 h | >4 h | 0 | 43 | >4 h | >4 h | 5 | 48 |
| | 6 | >3 h | >3 h | 0 | 20 | >3 h | >3 h | 0 | 45 |
| | 7 | >2 h | >2 h | 0 | 8 | >2 h | >2 h | 0 | 30 |
| 40 h | 8 | >1 h | >1 h | 0 | 0 | >1 h | >1 h | 0 | 0 |
| 6th day | 0 | >9 h | >9 h | 0 | 28 | 5 h 53′ | >9 h | 83 | 95 |
| | 1 | >8 h | >8 h | 0 | 10 | 4 h 43′ | >8 h | 98 | 93 |
| | 2 | >7 h | >7 h | 0 | 0 | 3 h 28′ | >7 h | 93 | 93 |
| | 3 | >6 h | >6 h | 0 | 0 | >6 h | >6 h | 48 | 60 |
| | 4 | >5 h | >5 h | 0 | 0 | >5 h | >5 h | 20 | 28 |
| | 5 | >4 h | >4 h | 0 | 0 | >4 h | >4 h | 20 | 30 |
| | 6 | >3 h | >3 h | 0 | 0 | >3 h | >3 h | 5 | 23 |
| | 7 | >2 h | >2 h | 0 | 0 | >2 h | >2 h | 0 | 0 |
| 48 h | 8 | >1 h | >1 h | 0 | 0 | >1 h | >1 h | 0 | 0 |

*kd/mortality following commencement of operation of the heating devices

### Example 8.3

Insecticidal activity of vaporizer tablets from Example 6.3 against susceptible mosquitos of the species Aëdes aegypti in 34 m³ rooms

Temperature: 22-25° C.

Relative atmospheric humidity: 15-31%

(Mean values of 3 trials)

| | FALP standard | | | | |
|---|---|---|---|---|---|
| | heater, vaporizer | | | | |
| | tablets from | | | | |
| | Example 6.3 | | | | |
| | (1.32% Transfluthrin) | | | % Mortality | |
| Test after | KD action in min/h | | | after | |
| hours | 10% | 50% | 100% | 9 h* | 24 h** |
| 0 | 23′ | 27′ | 34′ | 100 | 100 |
| 1 | 1′ | 2′ | 4′ | 100 | 100 |
| 2 | 1′ | 2′ | 3′ | 100 | 100 |
| 3 | 1′ | 2′ | 4′ | 100 | 100 |
| 4 | 1′ | 2′ | 4′ | 100 | 100 |
| 5 | 1′ | 2′ | 4′ | 100 | 100 |
| 6 | 1′ | 2′ | 5′ | 100 | 100 |
| 7 | 1′ | 2′ | 4′ | 100 | 100 |
| 8 | 1′ | 2′ | 4′ | 100 | 100 |

*9 hours after beginning of operation of the heating devices
**24 hours after beginning of operation of the heating devices

### Example 8.4

Insecticidal Activity of Vaporizer Tablets from Example 6.3 against Resistant Mosquitos of the Species Culex quinquefasciatus in 34 m³ Rooms

Temperature: 22-25° C.

Relative atmospheric humidity: 15-31%

(Mean values of 3 trials)

| | FALP standard heater, | | | | |
|---|---|---|---|---|---|
| | vaporizer tablets from | | | | |
| | Example 6.3 | | | | |
| | (1.32% Transfluthrin) | | | % Mortality | |
| Test after | KD action in min/h | | | after | |
| hours | 10% | 50% | 100% | 9 h* | 24 h** |
| 0 | 1 h 46′ | 2 h 36′ | 3 h 44′ | 100 | 100 |
| 1 | 1 h 10′ | 1 h 58′ | 3 h 28′ | 100 | 100 |
| 2 | 1 h 01′ | 1 h 48′ | 3 h 38′ | 100 | 100 |
| 3 | 1 h 20′ | 2 h 36′ | 4 h 36′ | 100 | 100 |
| 4 | 1 h 12′ | 2 h 18′ | 3 h 40′ | 100 | 100 |
| 5 | 1 h 08′ | 2 h 00′ | — | 93 | 100 |
| 6 | 59′ | >3 h | — | 83 | 100 |
| 7 | >2 h | — | — | 44 | 77 |
| 8 | — | — | — | 5 | 27 |

*9 hours after beginning of operation of the heating devices
**24 hours after beginning of operation of the heating devices

### Example 8.5

Insecticidal Activity of Vaporizer Tablets from Example 6.4 Against Susceptible Mosquitos of the Species Aëdes aegypti in 34 m³ Rooms

Temperature: 22-26° C.

Relative atmospheric humidity: 34-45% an values of 2 trials)

| | FALP standard | | | | |
|---|---|---|---|---|---|
| | heater vaporizer | | | | |
| | tablets from Example | | | | |
| | 6.4 (2% Transfluthrin) | | | % Mortality | |
| Test after | KD action in min/h | | | after | |
| hours | 10% | 50% | 100% | 9 h | 24 h |
| 0 | 20′ | 27′ | 31′ | 100 | 100 |
| 1 | 1′ | 2′ | 3′ | 100 | 100 |
| 2 | 1′ | 2′ | 3′ | 100 | 100 |
| 3 | 1′ | 2′ | 3′ | 100 | 100 |
| 4 | 1′ | 2′ | 3′ | 100 | 100 |
| 5 | 1′ | 2′ | 3′ | 100 | 100 |
| 6 | 1′ | 2′ | 4′ | 100 | 100 |
| 7 | 1′ | 2′ | 5′ | 100 | 100 |
| 8 | 3′ | 5′ | 8′ | 100 | 100 |

### Example 8.6

Insecticidal Activity of Vaporizer Tablets from Example 6.4 Against Resistant Mosquitos of the Species Culex quinquefasciatus in 34 m³ Rooms

Temperature: 22-26° C.

Relative atmospheric humidity: 34-45%

(Mean values of 2 trials)

| | FALP standard heater, vaporizer tablets from | |
|---|---|---|
| | Example 6.4 (2% Transfluthrin) | |
| Test after | KD action in min/h | % Mortality after |

| hours | 10% | 50% | 100% | 9 h | 24 h |
|---|---|---|---|---|---|
| 0 | 1 h 05′ | 1 h 27′ | 2 h 12′ | 100 | 100 |
| 1 | 32′ | 55′ | 1 h 49′ | 100 | 100 |
| 2 | 31′ | 1 h 00′ | 2 h 13′ | 100 | 100 |
| 3 | 42′ | 1 h 23′ | 2 h 25′ | 100 | 100 |
| 4 | 46′ | 1 h 19′ | 2 h 29′ | 100 | 100 |
| 5 | 51′ | 1 h 36′ | 2 h 48′ | 100 | 100 |
| 6 | 53′ | 1 h 40′ | >3 h | 88 | 98 |
| 7 | 1 h 10′ | >2 h | >2 h | 45 | 73 |
| 8 | >1 h | >1 h | >1 h | 2 | 22 |

1. Formulations based on
A) at least one pyrethroid insecticide which is released at elevated temperatures and
B) at least one polymer having a softening point between 100 and 300° C., characterized in that they contain an inorganic aggregate and/or in that the polymer is poly-4-methylpentene.

2. Formulations according to claim 1, characterized in that they contain 3-allyl-2-methyl-cyclopent-2-en-4-on-1-yl-d/l-cis/trans-chrysanthemate (allethrin/Pynamine®),
3-allyl-2-methyl-cyclopent-2-en-4-on-1-yl-d-cis/trans-chrysanthemate (Pynamin forte®),
3-allyl-2-methyl-cyclopent-2-en-4-on-1-yl-d-trans-chrysanthemate (Bioallethrin®),
2,3,5,6-tetrafluorobenzyl (+)-1R-trans-2,2-dimethyl-3-(2,2-dichlorovinyl)-cyclopropanecarboxylate (transfluthrin, Bayothrin®))
or mixtures of these active compounds
as insecticidally active compounds.

3. Formulations according to claim 1, characterized in that they contain 2,3,5,6-tetrafluorobenzyl (+)-1 R-trans-2,2-dimethyl-3-(2,2-dichlorovinyl)-cyclopropanecarboxylate (transfluthrin, Bayothrin®) as insecticide.

4. Formulations according to claim 1, characterized in that they contain, as polymers, PVC (SOFT), polystyrene, styrenelbutadiene, styrene/acrylonitrile, acrylonitrile/butadiene/styrene, polymethacrylate, amorphous polycycloolefins, cellulose esters, aromatic polycarbonates, amorphous aromatic polyamides, polyphenylene ethers, poly (ether) sulphones, polyimides, polyethylene, polypropylene, polybutylene, polymethylpentene, PVC (HARD), polyamide, polyetheramides, polyesteramides, polyoxymethylene, polyethylene terephthalate, polybutylene terephthalate, polyimide, polyether (ether) ketone and polyurethanes, blends of polycarbonates with polybutylene terephthalate, blends of polyamide-6 and styrene/acrylonitrile, blends of polypropylene and polymethylpentene or mixtures of the polymers mentioned.

5. Formulations as claimed in claim 1, characterized in that they contain polymethylpentene or mixtures of polymethylpentene and polypropylene as polymer.

6. Insecticidal compositions according to claim 1, characterized in that they contain minerals such as, for example, gypsum, lime, glass fibres or sand as inorganic aggregates.

7. Formulations according to claim 1 comprising mixtures containing
A. from 0.1 to 80% by weight of transfluthrin and
B. from 99.9 to 20% by weight of poly-4-methyl-1-pentene, which in turn can be replaced up to half its weight by another poly-α-olefin,
the percentages being based in each case on the sum of the components A+B.

8. Process for producing formulations according to claims 1 to 7 by mixing the components and shaping the resulting mixture.

9. Use of formulations according to claims 1 to 7 for the control of insects.
